(19) United States
(12) Patent Application Publication
(10) Pub. No.: US 2012/0183945 A1
(43) Pub. Date: Jul. 19, 2012

(54) METHOD, DEVICE AND FLUID FOR TREATMENT OF A HEART AFTER HARVESTING

(75) Inventors: Stig Steen, Lund (SE); Audrius Paskevicius, Lund (SE)

(73) Assignee: VIVOLINE MEDICAL AB, Lund (unknown)

(21) Appl. No.: 13/498,155

(22) PCT Filed: Sep. 22, 2010
(86) PCT No.: PCT/SE2010/000227

§ 371 Date: Mar. 26, 2012

Related U.S. Application Data
(60) Provisional application No. 61/278,458, filed on Oct. 8, 2009.

(30) Foreign Application Priority Data
Sep. 24, 2009 (SE) 0901235-2

(51) Int. Cl. A01N 1/02

(52) U.S. Cl. 435/1.2; 435/284.1

(57) ABSTRACT

Method and device for treatment of a heart after harvesting and before transplantation. The device includes a container intended to comprise the heart; a first line for connection to an aorta of the heart; a fluid circuit comprising an oxygenator for oxygenating said fluid and a heater/cooler for regulating the temperature of said fluid; and a pump for perfusion of said fluid through the coronary blood vessels of the heart. The fluid includes an oncotic agent exerting an oncotic pressure larger than about 30 mmHg; and is cardioplegic by comprising a potassium concentration, which is between 15 mM and 30 mM. A control device is arranged for controlling the pump to perform said perfusion intermittently, whereby the perfusion time is less than half of the cycle time. The perfusion is performed at a pressure, which is at least 15 mmHg and at least 15 mmHg lower than said oncotic pressure.

### FIELD OF INVENTION

The present invention relates to a method and a device for treatment of a heart after harvesting and a perfusion fluid therefore.

### BACKGROUND OF THE INVENTION

It is well known that there is a great shortage of donor organs, which are suitable for transplantation.

Hemodynamic instability during brain death of a heart-beating donor is often associated with the deterioration or graft viability, leading to organ exclusion. A careful attention to the donor before, during and after the brain death and before harvesting is essential. However, when the organ is harvested, it is equally essential that the careful attention to the organ be continued.

There is a need for a method of treating an organ, such as the heart, intended for transplantation, after harvesting, which decreases the rejection rate of organs that are harvested from such donors, specifically when the organ has been relatively carefully treated before harvesting.

### SUMMARY OF THE INVENTION

Accordingly, an object of the present invention is to mitigate, alleviate or eliminate one or more of the above-identified deficiencies and disadvantages singly or in any combination.

According to an aspect of the invention, there is provided method for treatment of a heart after harvesting and before transplantation, comprising: arranging the heart in a container; connecting an aorta of the heart to a source of a perfusion fluid; oxygenating and possibly regulating the temperature of said fluid; perfusion of said fluid through the coronary blood vessels of the heart; wherein said fluid comprising an oncotic agent exerting an oncotic pressure larger than about 30 mmHg; said fluid being cardioplegic; and said perfusion being performed at a pressure, which is at least 15 mmHg and at least 15 mmHg lower than said oncotic pressure.

In an embodiment, said perfusion is performed intermittently, whereby a perfusion time is less than half of a cycle time.

In a further embodiment, at least one of the following conditions is fulfilled: said perfusion time is between 1 minute and 30 minutes; said perfusion time is between 5 minute and 25 minutes; said perfusion time is between 7 minute and 20 minutes; said perfusion time is between 10 minute and 15 minutes; said cycle time is between 10 minutes and 120 minutes; said cycle time is between 20 minutes and 110 minutes; said cycle time is between 45 minutes and 90 minutes; said cycle time is between 60 minutes and 75 minutes; said perfusion time divided by said cycle time is smaller than 50%; said perfusion time divided by said cycle time is between 5% and 45%; said perfusion time divided by said cycle time is between 10% and 30%; said perfusion time divided by said cycle time is about 20%; said potassium concentration is between 15 mM and 30 mM; said potassium concentration is between 18 mM and 28 mM; said potassium concentration is between 20 mM and 26 mM; said potassium concentration is between 22 mM and 24 mM; said oncotic pressure is larger than 30 mmHg; said oncotic pressure is larger than 40 mmHg; said oncotic pressure is larger than 50 mmHg; said oncotic pressure is larger than 60 mmHg; said oncotic pressure is smaller than 70 mmHg; said perfusion pressure is between 15 mmHg and 50 mmHg; said perfusion pressure is between 17 mmHg and 35 mmHg; said perfusion pressure is between 20 mmHg and 30 mmHg.

In another further embodiment, the method may further comprise: controlling a perfusion flow rate by said perfusion pressure so that said perfusion pressure is substantially constant and the perfusion flow rate is between predetermined limits.

In a still further embodiment, the method may further comprise: measuring the oxygenation level of fluid exiting the heart during perfusion and controlling the perfusion time so that the perfusion is ended when a predetermined oxygenation level is obtained in the fluid exiting the heart.

In a yet further embodiment, the method may further comprise: monitoring at least one of the following parameters of the fluid: temperature; pressure before the heart; pressure after the heart; flow rate; oxygenation level before the heart; oxygenation level after the heart; pH; carbon dioxide level; color; and adjusting the perfusion in accordance with at least one of said parameters.

In another embodiment, the method may further comprise: circulating said fluid through said container but outside said heart, between the perfusion steps at least shortly before the initiation of perfusion.

In another aspect, there is provided a container intended to comprise the heart; a first line for connection to an aorta of the heart; a fluid circuit comprising an oxygenator for oxygenating said fluid and a heater/cooler for regulating the temperature of said fluid; a pump for perfusion of said fluid through the coronary blood vessels of the heart; wherein said fluid comprising an oncotic agent exerting an oncotic pressure larger than about 30 mmHg; said fluid being cardioplegic; a control device for controlling the pump whereby said perfusion is performed at a pressure which is at least 15 mmHg and is at least 15 mmHg lower than said oncotic pressure.

In an embodiment, the control device may be arranged to perform said perfusion intermittently, whereby a perfusion time is less than half of a cycle time.

In a further embodiment, the cardioplegic solution may comprise potassium at a concentration, which is lower than 30 mM, but sufficiently high to cause cardioplegia, such as above about 15 mM.

In another embodiment, the device may further comprise: a first clamp arranged on said fluid line outside said container; a second clamp arranged at a branching line, which branches from said fluid line inside said container shortly before the connection of said fluid line to said aorta, and passes through said second clamp outside said container and back to said container; and wherein said first clamp is open during perfusion; said second claim is open shortly before perfusion at the same time as said first clamp is open in order to flush said fluid line before initiation of perfusion.

In a further embodiment, there may be provided a third clamp, which is arranged at a division line dividing from said first line before said first clamp and ending inside said container; whereby said third claim is open during circulation outside said heart in the container, whereby at the same time at least the first clamp is closed.

In a further aspect, there is provided a fluid for treatment of a heart after harvesting and before transplantation as described above, comprising: an oncotic agent exerting an oncotic pressure larger than about 30 mmHg; a cardioplegic substance; erythrocytes comprising at least a hematocrit of 5%; a nutritional substance; and electrolytes in substantially physiologic concentrations.

In an embodiment, said cardioplegic solution may be potassium having a concentration, which is lower than 30 mM, but sufficiently high to cause cardioplegia, such as above 15 mM.

In another embodiment, the fluid may comprise: 60 g/L of Dextran 40; 7.0 g/L of NaCl; 1.71 g/L of KCl; 0.22 g/L of CaCl₂*2H₂O; 0.17 g/L of NaH₂PO₄*H₂O; 1.26 g/L of NaHCO₃; 0.24 g/L of MgCl₂*6H₂O; 1.98 g/L of D(+) glucose, erythrocytes at a hematocrit of at least 5% and optionally 50 ml of albumin (20%).

### BRIEF DESCRIPTION OF THE DRAWINGS

Further objects, features and advantages of the invention will become apparent from the following detailed description of embodiments of the invention with reference to the drawings, in which:

FIG. 1 is a schematic diagram of a first embodiment of the invention.

FIG. 2 is a schematic diagram of a second embodiment of the invention.

FIG. 3 is a schematic diagram of a portion of FIG. 2.

FIG. 4 is a schematic diagram of a third embodiment of the invention.

### DETAILED DESCRIPTION OF EMBODIMENTS

Below, several embodiments of the invention will be described. These embodiments are described in illustrating purpose in order to enable a skilled person to carry out the invention and to disclose the best mode. However, such embodiments do not limit the scope of the invention. Moreover, other combinations of the different features are possible within the scope of the invention.

An object of the below described embodiments is to improve the outcome of organ harvested from a heart-beating donor, which has been declared brain death.

The process of becoming brain death is a traumatic experience for the body and its organs. Brain death means that the brain ceases to operate including the brain stem. Since respiration is controlled by the brain stem, respiration will also cease.

In a normal situation in a hospital, the doctor allows the patient to rest for about another 20 to 30 minutes after brain death, without any intervention. Without lung respiration, the oxygen supply to the body organ will cease and the organs will loose the function because of lack of oxygen. Finally, the heart stops operating after some 20 minutes, and the body continues cooling to ambient temperature. The next of kin can pay their respect to the dead person.

After about 1 hour, most of the organs have been destroyed and cannot be used for transplantation purpose.

If the patient or the next of kin have consented to organ donation, intervention can be initiated as soon as the brain death condition has been declared.

Normally, brain death involves that the intracranial pressure exceeds the systolic blood pressure, resulting in that the brain is exposed to an ischemic condition, because blood cannot enter the brain. The brain may react by increasing the heart rate and flow and by increasing the systemic vascular resistance. In addition, the adrenal gland may increase the level of adrenalin (epinephrine) and nor-adrenaline (nor-epinephrine). This is called the Cushing reflex. The heart rate may increase by several hundred percent, to a maximum heart rate. The blood pressure may increase to above 200 mmHg. This massive reaction is also called the “catecholamine storm” or “sympathetic autonomous storm”.

In Sweden, brain death is defined as irreversible loss of function of the entire brain including the brainstem. There are several indicia of brain death, which are of less interest for the present embodiments. However, after brain death, there is no cerebral blood circulation and no spontaneous respiration. The body temperature should be above 33° C. and there should be no drug intoxication.

Patent publication WO 2010/077200 A1 discloses a method of treatment of the body immediately after brain death so that the heart will not stop beating and respiration is maintained. In this way, the organs are treated as well as the circumstances permit. Normally, harvesting is performed within a few hours, at least within 24 hours. The contents of said patent publication WO 2010/077200 A1 is incorporated in the present specification by reference.

There are a number of different strategies suggested in the literature for maintaining organs after brain death. The fact that it is possible with prolonged somatic support has been reported for a pregnant woman with brain death. By full ventilatory and nutritional support, vasoactive drugs, maintenance of normothermia, hormone replacement and other supportive measures, the fetus could be born several weeks after brain death of the mother, thereby improving the survival prognosis for the fetus.

In Sweden, it is permitted to maintain the donor during 24 hours after brain death until organ harvesting is performed. After harvesting, the organs are examined for viability and preserved as described below.

In order to preserve the heart, certain conditions should be fulfilled in order to improve the outcome of the preservation. The “better” the heart is from the start at harvesting, the better are the prospects of a favorable storage and transplantation outcome.

Thus, a presumptive heart of a heart-beating donor should fulfill one or several of the following conditions before harvesting:

1) Oxygenation is an issue. If the heart is exposed for ischemic conditions during a long time, for example more than 20 to 30 minutes, irreparable harm may be caused on the heart. Since many patients, who become heart donors after brain death, are vigorously treated to keep them alive before giving up, such patients are normally exposed to forced ventilation. Such respiration is continued all the time. When the brain stem ceases to operate, the patient is declared brain dead, but forced ventilation and respiration continues if the patient has given his consent to donation of organs or the next in kin gives such consent. Thus, the heart is properly oxygenated all the time until harvesting. If respiration is not performed at brain death declaration or is added too late, the heart may be unsuitable for transplantation.

2) Blood pressure is another issue. The blood pressure should be kept sufficiently high after brain death in order to keep perfusion of the heart muscle. Thus, a mean blood pressure of at least 40 mmHg, such as more than 50 mmHg, for example more than 60 mmHg should be maintained.

3) Vasoconstriction is still another issue. If the patient after brain death is exposed to agents causing vasoconstriction, such as excessive amounts of vasopressin, ADH, dopamine, adrenaline (epinephrine), nor-adrenaline (nor-epinephrine) etc., the heart may not be properly perfused and part of the heart may become ischemic.

4) Hormone balance is a further issue. There are several hormones that should be controlled, such as T3, and cortisone. If these hormones are at too low levels, the heart may be less well suited for long time preservation and transplantation.

5) Temperature is a still further issue. When the patient becomes brain death, the temperature control centrum does not operate. The body still has some metabolism, causing release of heat, although normally the body cools down slowly. If the body is allowed to cool, the metabolism and the consumption of hormones will be slowed down. Thus, a decrease to about 30° C. may be appropriate, but the harvesting of the organs should be performed at a temperature of no less than about 34° C.

If one or several of these issues are controlled, the heart may be considered well treated and can be preserved for a long time after harvesting.

After maintaining the patient in a good condition after brain death, the organs are harvested, normally within 24 hours.

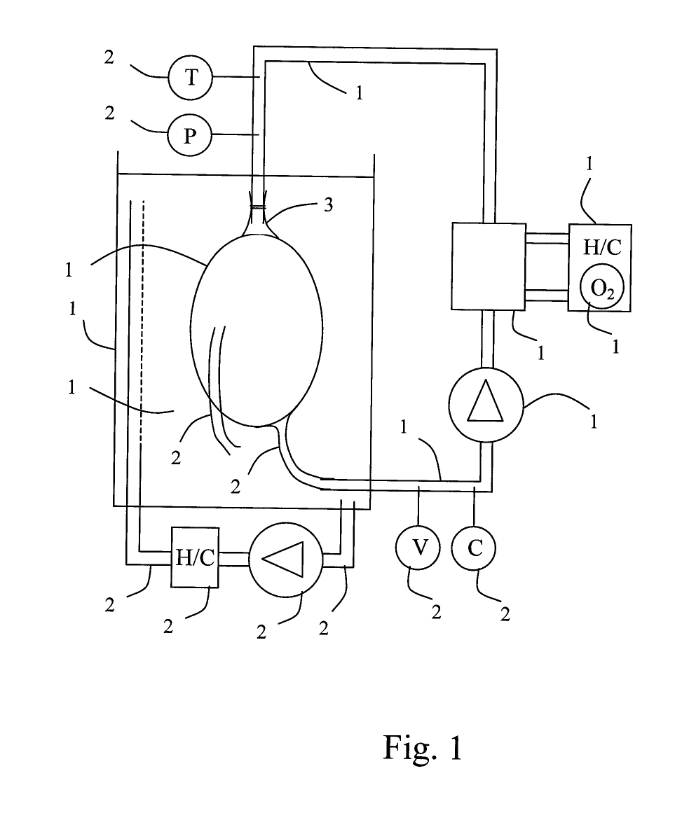

An embodiment is described below with reference to FIG. 1. The heart 11 is arrested and excised, whereupon the aorta 30 of the heart is connected to a first tube 13 and the inferior and/or superior vena cava 28, 29 extending from the right atrium is/are connected to a second tube 14. Then, the heart is arranged in a container 12, which is filled with a fluid 15.

The heart is hanging in the first tube 13 and extends vertically inside the container 12.

The first tube 13 and the second tube 14 are connected in a flow circuit, which further comprises a pump 16 and an oxygenator 17 provided with a heater/cooler 18 and a source of oxygen 19. In addition, the flow circuit comprises several sensors, such as a temperature sensor 20, and a pressure sensor 21.

The container 12 is provided with a separate circulator comprising an outlet tube 23, a pump 24, a heater/cooler 25 and an inlet tube 26.

The fluid in the container may be the same as in the flow circuit. However, the fluid in the container may be different from the fluid in the flow circuit, see further below.

The fluid in the flow circuit comprises one or several or all of the following components.

1) Electrolytes in physiological concentrations.

2) Potassium ions in higher concentrations, as discussed below.

3) An oncotic agent for providing a specific oncotic pressure, as discussed below.

4) An oxygen carrier, such as erythrocytes, in a sufficient amount in order to carry oxygen and carbon dioxide.

5) An energy source, such as glucose.

6) Optional further agents, as discussed below.

When the heart is arranged in the container, the first action is to provide the heart with oxygenated fluid in order to prevent an ischemic condition of the heart. Simultaneously, the heart is kept arrested since the provided fluid is cardioplegic, for example because of high potassium concentration. Thus, the pump 16 is started and oxygen is supplied to the oxygenator 17 from the source of oxygen 19.

At the same time or before, the heart is cooled as rapidly as possible to a preservation temperature, which may be about 10° C. by cooling the fluid in the oxygenator 17 by the heater/cooler 18 and/or by cooling the fluid in the container via heater/cooler 25. The heart is topically cooled from the outside via the fluid surrounding the heart as well as core cooling via the inner fluid in the flow circuit.

When these temperature and flow conditions have been achieved, the continued preservation takes place during paying attention to the following considerations.

1) At a low temperature, the metabolism of the heart is kept at a minimum.

2) The heart is not beating since the fluid is cardioplegic, which means that the metabolism is further reduced. The heart is hanging in a relaxed condition from the connection between the aorta and the tube 13.

3) A high potassium concentration may cause constriction of the coronary vessels, which should be avoided. However, the potassium concentration must be sufficiently high to cause cardioplegia.

4) At a low temperature, the endothelial cells of the coronary vessels are relatively sensitive and cannot withstand a high mechanical stress, because the cell walls are lipidic, making them more fragile at low temperatures.

5) Because the heart is not beating, there is a risk of water absorption and swelling or edema, which should be counteracted.

Having these considerations in mind, the following criteria apply for the fluid:

1) The potassium concentration should be sufficiently high to cause cardioplegia all the time but not too high in order to avoid vasoconstriction or other adverse actions. We have found that a potassium concentration of higher than 15 mM (mmol/L) may be sufficient in most cases. In order to guarantee that the heart will remain cardioplegic all the time, the concentration may be higher than 18 mM. In order to have a safety margin, the concentration may be higher than 20 mM. However, if the concentration is higher than 30 mM, the risk of vasoconstriction may be imminent. Thus, a potassium concentration of about 15 mM to 30 mM would be adequate, such as between 20 mM and 26 mM for example 23 mM. Other known methods of causing cardioplegia may be used.

2) The oncotic pressure should be sufficient to counteract swelling. We have found that an oncotic pressure higher than 30 mmHg would be sufficient in most cases, although 40 mmHg would guarantee that swelling does not occur. Since the heart is exposed to a mechanical pressure during circulation, an oncotic pressure of between 50 mmHg and 70 mmHg may be used in certain situations.

3) The coronary vessels of the heart should be provided with circulation of the fluid in order to provide oxygenation and nutrition as well as removal of vaste products. The fluid flow is antegrade, from the aorta to the coronary vessels and further to the atrium. Normally, the aortic valve is closed so that no fluid flow takes place to the left ventricle. We have found that the circulation should be performed at as low pressure as possible, because the pressure in the fluid in the coronary vessel will tend to move water into the cells and interstitial fluid and cause swelling. On the other hand, the pressure should be sufficiently high to extend the capillaries and cause the fluid to flow in all coronary vessels substantially all the time. Thus, the pressure should be sufficiently high to avoid preferential flows in only a few coronary vessels. In this manner, the entire heart will be perfused by the fluid. In order to ensure that no swelling occurs and no preferential flows occur, the circulation pressure should be above about 15 mmHg in order to prevent preferential flows, and below about 30 mmHg in order to counteract swelling. The pressure should always be lower than the oncotic pressure of the fluid, such as 15 mmHg to 30 mmHg lower than the oncotic pressure in order to prevent swelling.

4) It is recognized that the endothelial cells are sensitive to mechanical action, especially at a low temperature. Thus, the circulation of the fluid should take place during as short time as possible. The circulation may be continuous, but the pressure should be sufficiently high to prevent preferential flows. A more gentle action may be obtained if the circulation is intermittent. Since the circulation pressure is relatively high in order to avoid preferential flows, the intermittent flow may have a duty cycle, which is less than 50%. A proper perfusion may be obtained if the duty cycle is between 5% and 45%, such as between 10% and 30%, for example 20%. Duty cycle means the time of flow divided by the total cycle time, i.e. the time of flow plus the time of non-flow.

5) Because the metabolism is rather slow at low temperature, it has been found that the heart can withstand ischemic condition during at least 60 minutes, such as up to 120 minutes, without being damaged. Thus, intermittent perfusion of the heart is performed at cycle times, which are shorter than 120 minutes, such as shorter than 75 minutes, for example about 60 minutes.

6) When perfusion is initiated, the fluid exiting the right atrium to the outlet tube 14 is dark red, because the fluid is depleted of oxygen. The fluid introduced into the heart via inlet tube 13 is light red, because the fluid is oxygenated. It takes some time until the fluid exiting via outlet tube 14 changes color and becomes more light red. This is an indication that the entire heart has been properly oxygenated. Now the circulation may be interrupted and the heart may rest to the next perfusion. The perfusion may be continued for a specified time period of for example 5 minutes. This period should be sufficiently long for ensuring that the heart is properly oxygenated and that metabolic end products are removed.

Thus, a perfusion scheme may be to perfuse the heart during 15 minutes at a pressure of from 20 mmHg to 30 mmHg, for example 25 mmHg, having a fluid with an oncotic pressure of about 60 mmHg. Then, the heart is left without perfusion during about 45 minutes, resulting in a cycle time of 60 minutes, and the process is repeated.

The oncotic pressure may be obtained by Dextran 40 or Dextran 70 or albumin or any combination thereof. Other substances for generating an oncotic pressure may be used, for example colloids, such as hydroxyethyl starch.

In the non-perfusion time, the second pump 24 is operated in order to keep the temperature at the desired temperature and also to cause some agitation. Fluid is removed from the container via outlet tube 23 and introduced to the container via inlet tube 26. The inlet tube may be provided with openings along the length thereof, in order to introduce fluid at different levels to cause mixing and blending of the fluid.

It may be sufficient to operate the pump 24 intermittently, especially when the surrounding atmosphere is relatively cool.

The temperature is maintained between about 4° C. to about 20° C., such as about 10° C.

Since the flow resistance of the heart is individual, it may be required to fine-tune the pressure and the flow rate, which may be performed by adjusting the pressure so that light red fluid exits the heart at the end of a perfusion period.

The fact that the outlet fluid via the outlet tube 14 is light red can be monitored by a spectrophotometric sensor or color sensor 27. When the color sensor determines that the fluid is dark red, the flow continues and when the color sensor 27 determines that the fluid is light red, it is safe to end the perfusion. Thus, the color sensor 27 is used as a safety indicator that the process is proper.

The color sensor 27 may alternatively be used to automatically end the perfusion step when the color is light red, independently of the perfusion time. In this case, the color sensor 27 controls the perfusion time.

Another way to use the signal from the color sensor 27 is the following. If the change to light red takes place already before 14 minutes, the color sensor may influence upon the perfusion pressure and lower the perfusion pressure for the next cycle, for example decreasing the perfusion pressure by 1 mmHg. This adaptive operation continues until an optimal perfusion pressure has been obtained, so that perfusion takes place during 15 minutes. If the outlet fluid is not sufficiently light red after 15 minutes, the perfusion pressure may be increased. The operation may be adjusted to another perfusion time than 15 minutes, such as 7 minutes or any time desired.

The color sensor 27 may be replace by a conventional oxygen meter, which determines the oxygen saturation of the fluid. Alternatively or in addition, a pH-meter may be used to measure the pH of the fluid exiting the heart.

A micro-dialysator tube may be introduced into the vena cava in order to extract a small amount of the fluid, which is then analyzed externally for oxygen level, carbon dioxide level, pH, glucose, and other parameters.

The operation may also be monitored by a flow meter 22. The perfusion may be considered to be sufficient when a specified amount or volume of fluid has been perfused through the heart. Since the vessel system of the heart normally may have a volume of less than about 100 ml, the perfusion may be considered sufficient when a volume of 500 ml has been perfused.

Alternatively or additionally, the pump 16 may operate as a flow meter.

The oxygen level in the fluid passing to the heart via inlet line 13 is oxygenated, which means that the oxygenation level is close to 100%, such as 98%, as is the case for arterial blood in the body. Normally, the oxygen level in the body decreases to 60% in the venous blood. However, the coronary vessels and the heart muscle are special in that they may extract oxygen from the fluid down to an oxygen saturation level of about 15%. Thus, even if the blood exiting the heart is dark red, there is still a good safety margin as to oxygen supply.

The vascular resistance of the coronary vessels is dependent on many factors. It is noted that the vascular resistance of the coronary vessels may be smaller at the start and increase during the perfusion.

If the potassium concentration is high, there is a risk of vasoconstriction, which may result in preferential flows, since some of the vessels may be blocked.

A low flow as measured by the flow meter 22 and a high pressure as measured by the pressure meter 21 are indications of vasospasm. In this situation, a lowering of the potassium concentration may be appropriate.

Another cause of increase of vascular resistance may be formation of edema, i.e. water absorption of the interstitial tissue, which in this specification is called swelling. When the pressure in the coronary vessels increases during the perfusion, the oncotic pressure of the fluid may be insufficient to balance the water absorption. Thus, swelling occurs and the vascular resistance may increase. In the time between perfusion, the swelling may be reversed or removed, since the oncotic pressure does not need to balance the perfusion pressure.

The fluid inside the container 12 and the fluid in the circuit comprising tubes 13 and 14 may be the same.

Although the outlet tube 14 has been indicated to be inserted in the right atrium, there are several vessels that connect the heart with the container fluid, such as the four pulmonary veins and the pulmonary arteries.

However, since the circuit from the inlet tube 13 to the outlet tube 14 is closed, the fluid circulated in this circuit will be substantially the same. The coronary vessels start as coronary arteries from the aorta close to the aortic valve, which is closed. The coronary vessels end as coronary veins, which open into the right atrium. However, the pulmonary valve connecting the right ventricle with the pulmonary arteries is normally closed. Thus, the circuit is relatively independent from the vessels opening to the container 12. This makes it possible to have different fluids in the flow circuit 13, 14 and in the container 12.

The flow circuit 13, 14 may comprise a fluid as defined in more detail below, including erythrocytes and an oncotic agent and potassium, while the container 12 may comprise a cheaper fluid, for example without erythrocytes.

If the fluid in the container 12 is the same as the fluid in the circuit 13, 14, the connections between the outlet tube 14 and the venae cavas 28, 29 do not need to be substantially tight. It may be sufficient to insert the end of the outlet tube 14 into one of the vena cavae 28 while allowing the other vena cava 29 to open into the container as shown in FIG. 1. If the outlet tube 14 becomes blocked, the pressure inside the heart will not increase uncontrolled, since the fluid may pass out via the other vena cava.

It may be desired to have different temperatures in the circuit 13, 14 etc and in the container 12. For example, the container may comprise fluid with a temperature of about 10° C. while the fluid circulating in the circuit 13, 14 may have a temperature of 25° C. or even up to 37° C.

The fluid in the circuit may comprise erythrocytes as carrier of oxygen. Since the oxygen demand is different at different temperature, the hematocrit may be different for different temperatures. Thus, if the temperature is low, such as about 5° C., the hematocrit may be about 5%, while, if the temperature is about 15° C., it may be appropriate with a hematocrit of about 10% to 15%.

The erythrocytes may be replaced by other oxygen carriers, such as artificial “red blood cells” or other substances.

There is a risk that the red blood cells in the fluid of the container will sediment and be assembled at the bottom of the container. Such sedimentation may be counteracted by keeping the pump 24 operating all the time. However, the fluid in the container 12 may substantially not be oxygenated.

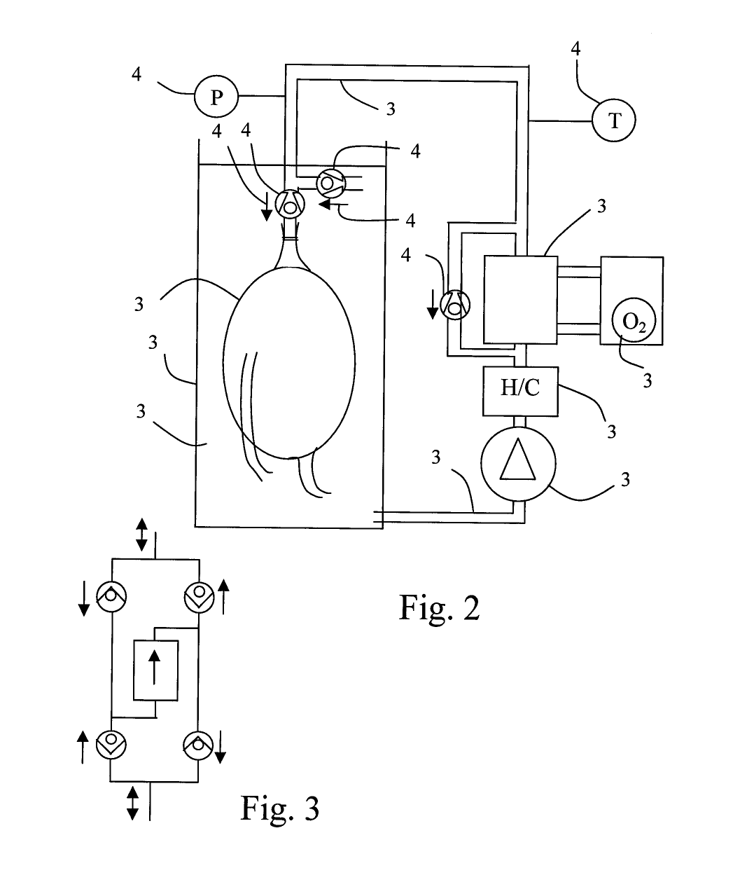

A second embodiment is shown in FIG. 2. The container 32 comprises the heart 31, which is immersed in a fluid 35. An outlet tube 34 opens directly to the container 32 at the bottom thereof. A pump 36 circulates fluid via the outlet tube 34, a heater/cooler 38 and an oxygenator 37 to an inlet tube 33. The oxygenator is provided with a source of oxygen 39.

The inlet tube 33 is provided with two back-flow valves, a first valve 41 and a second valve 42, which allow fluid flow in one direction only as shown by arrows 43, 44.

During perfusion, the flow takes place from the bottom of the container 32, via outlet tube 34 and pump 36, and via a heater/cooler 38 and oxygenator 37 to the inlet tube 33. Then, the flow passes the first valve 41 into the aorta of the heart and through the coronary vessels and out to the container via the vena cava.

When perfusion is ended, the flow direction of the pump 36 is reversed and the flow takes place in the other direction. Now, the first valve 41 is closed and the flow takes place via the second valve 42 and into the inlet tube 33, via a third back-flow valve 40 bypassing the oxygenator 37 and via the pump 36 back to the bottom of the container 35 via outlet tube 34. In this way, the fluid inside the container 35 is agitated between the perfusion steps, which prevents sedimentation. In addition, the fluid is cooled by the separate heater/cooler 38. The oxygenator 37 is by-passed by the valve 40 because flow in the reverse direction may be undesired in the oxygenator.

An advantage of the second embodiment is that the perfusion operation and the non-perfusion operation are fully controlled by the flow direction of the pump. There are no electronically controlled valves that may malfunction. As soon as the pump flow is reversed, there is no perfusion. Moreover, the flow direction is advantageous for counteracting sedimentation.

If it is desired to keep the fluid oxygenated all the time, a flow reversal arrangement of back-valves may be used, comprising four back-flow valves, in a conventional arrangement, see FIG. 3. However, precautions should be undertaken to ensure that the pressure inside the oxygenator would not become too low.

The valves 41, 42 may be included in the tube 33 and may be easily sterilized before use.

In the second embodiment, it may be difficult to distinguish that the fluid exiting the vena cava shifts color from dark red to light red. However, the operation may be controlled in any other manner as outlined above. Alternatively, a catheter having a color sensor may be inserted in the vena cava.

The pump 36 may be a displacement pump, having a substantially linear relationship between the rotation rate of the pump and the flow. In this case, the pump may act as a flow meter. In addition, there should be at least a pressure meter 45, which monitors that the pressure does not exceed a specified maximum pressure, such as below 30 mmHg. In addition, a temperature meter 46 is required.

The pump may be a conventional peristaltic pump or a centrifugal pump or any other type of pump.

The operation may be controlled by having the pump 36 to rotate so that a predetermined pressure is obtained, such as 25 mmHg, as measured by the pressure sensor 45. At the same time it is monitored that the flow rate is within specified limits, such as between 50 ml/min and 200 ml/min. The perfusion takes place during 15 minutes. Then, the pump is reversed and continues to operate for 45 minutes in the other direction at a flow rate of for example 50 ml/min. This flow rate may be sufficient for preventing sedimentation and ensures that the fluid inside the container is sufficiently cold.

If the flow rate is too high, this may be caused by any short circuit in the heart, for example if the aorta valve is leaking. Then, an alarm is initiated and intervention to remove the problem should be undertaken. If the flow is too low, this may be caused by several errors, such as kinking of the tubes, or blockage of the coronary vessels. Then, an alarm is initiated and invention may be proper.

The agitation flow between perfusions may also be intermittent, for example 5 minutes of agitation flow followed by 5 minutes of no flow.

The agitation may be started a few minutes before the next perfusion. This is especially so if the cooling requirement is less, for example if the container including the pump, oxygenator etc, is arranged in a bag or box having insulating walls.

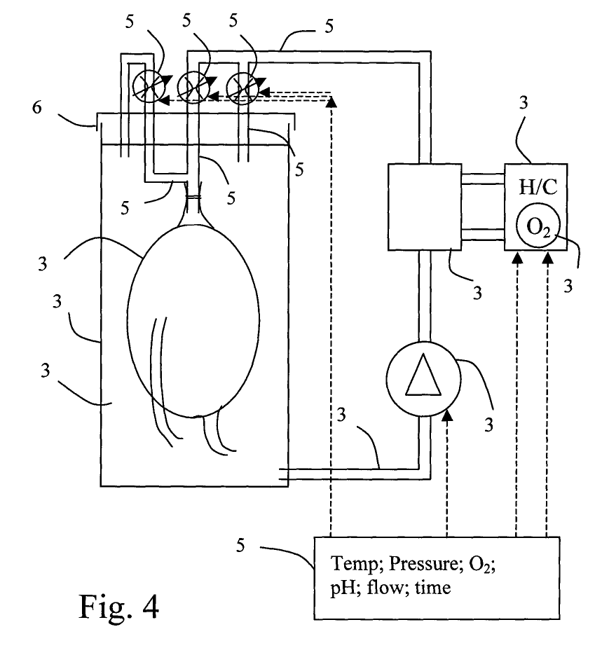

A third embodiment is shown in FIG. 4. The third embodiment is similar to the second embodiment and the same members are indicated by the same reference numerals. However, the back-flow valves 41, 42 are replaced by three clamps 51, 52 and 53. Each clamp is arranged at a tube and clamps the tube when operated so that no flow can take place. The clamps may be operated by screws driven by an electric motor, so that the valves require electric power only when moved from the open to the closed position and vice versa.

The flow of fluid from the oxygenator 37 takes place via a first tube 54, which is controlled by the first clamp 51. The first tube is connected to the aorta. Close to the connection to the aorta, the first tube 54 is divided into a second tube 55, which extends via the second clamp 52 back to the container 32, below the fluid level thereof. In addition, the first tube 54 is divided into a third tube 56 before the first clamp 51. The third tube 56 extends through the third clamp 53 and opens directly to the container 32 below the fluid level thereof.

The operation is the following.

During perfusion, the first clamp 51 is open and perfusion takes place through the aorta via first tube 54. When perfusion is ended, the first clamp 51 is closed and the third clamp 53 is opened, whereby fluid passes via first tube 54 and the third tube 56 to the container and agitation takes place. Agitation may be performed continuously or intermittently. Before perfusion starts again, the third clamp 53 is closed and the first and second clamps are opened. Because there is a vascular resistance in the coronary vessels of the heart, the fluid will now flow via the first tube 54 and via the first clamp 51 to the second tube 55 and via the second clamp 52 back to the container 32. In this manner it is assured that all fluid up to the division of line 55 is fresh and oxygenated. Finally, when perfusion should be started, the second clamp 52 is closed.

In a further embodiment, the third tube 56 and the clamp 53 are removed and the agitation takes place via tube 55 and clamp 52.

In another embodiment, only the second clamp 52 is arranged, i.e. clamps 51 and 53 are removed as well as tube 56. When perfusion should take place, the clamp 52 is closed and the entire flow takes place through the heart. When the perfusion is ended, the pump is stopped and no flow takes place. Shortly before the initiation of the next perfusion, the pump is started and clamp 52 is opened, whereby substantially only agitation of the fluid in the container takes place, since almost no fluid passes through the heart because of the flow resistance of the heart. When the fluid has become conditioned, such as oxygenated and obtained the right temperature, and when the sedimentation in the container has been removed, the clamp 52 is closed and the next perfusion takes place. In this case, a small perfusion may prevail during the conditioning step when the pump is operating and clamp 52 is open. However, such small perfusion may not be detrimental. In certain applications, it may be an advantage that the fluid flow at the start of the perfusion is initiated slowly in order to save the coronary blood vessels. In this case, the clamp 52 may close slowly over time, in order to increase the perfusion flow slowly.

The third embodiment may further be provided with a lid 61, which covers the container 32 during operation. Thus, the entire container 32 including the heart, and the pump and oxygenator can be arranged as a transportable unit.

The container 32 may be adapted to the shape of the heart so that it is relatively narrow. If the container 32 becomes inclined during transportation, the heart will still be arranged substantially parallel with the container as shown.

A computer 57 is arranged to control the entire operation of the pump 36, the oxygen supply 39, the heater/cooler 38 and the clamps 51, 52, 53 and in dependence of measured parameters, such as temperature of the fluid in inlet line 54 and in the container and at the outlet line 34, pressure in the inlet line 54 and the outlet line 34, oxygen level in the outlet line 34 and possibly also in the inlet line 54, pH in the inlet and outlet lines, flow rate and time, etc.

By means of the above described embodiments, the heart may be preserved during at least 24 hours after harvesting.

Because the heart is kept non-ischemic substantially all the time, there will be no reperfusion problems when the heart is transplanted, which is an advantage. Of course, the outcome also depends on any conditions the heart has been exposed to before harvesting, such as a cathecolamine storm, and lack of hormones after brain death and before harvesting.

During perfusion of the heart, the metabolic products are removed. Thus, the heart will not become acidotic during the preservation. In addition, the endothelial cells may be provided with a coating by means of Dextran.

Because the perfusion takes place at a pressure in which all coronary vessels, including capillaries, are perfused, no preferential routes are generated. Thus, all portions of the heart are perfused, which means that the oncotic fluid is transferred to the entire heart muscle. Thus, no edema or swelling will occur in any part of the heart.

A composition of the fluid used in the above embodiments may comprise the following substances:

Fluid 1: Dextran-40—60 g/L; NaCl—7.0 g/L, KCl—1.71 g/L (corresponding to 23 mM); CaCl₂*2H₂O—0.22 g/L; NaH₂PO₄*H₂O—0.17 g/L; NaHCO₃—1.26 g/L; MgCl₂*6H₂O—0.24 g/L; D(+) glucose—1.98 g/L.

Fluid 2: The same as fluid 1, with the addition of 50 ml albumin (20%) per liter.

Fluid 3: The same as fluid 2, but with only 55 g/L of Dextran-40.

In the claims, the term “comprises/comprising” does not exclude the presence of other elements or steps. Furthermore, although individually listed, a plurality of means, elements or method steps may be implemented by e.g. a single unit. Additionally, although individual features may be included in different claims or embodiments, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

Although the present invention has been described above with reference to specific embodiment and experiments, it is not intended to be limited to the specific form set forth herein. Rather, the invention is limited only by the accompanying claims and, other embodiments than those specified above are equally possible within the scope of these appended claims.

1. A method for treatment of a heart after harvesting and before transplantation, comprising:
arranging the heart in a container;
connecting an aorta of the heart to a source of a perfusion fluid;
oxygenating and possibly regulating the temperature of said fluid;
perfusion of said fluid through the coronary blood vessels of the heart;
wherein said fluid comprises an oncotic agent exerting an oncotic pressure larger than about 30 mmHg;
said fluid being cardioplegic; and
said perfusion being performed at a pressure, which is at least 15 mmHg and at least 15 mmHg lower than said oncotic pressure.

2. The method according to claim 1, wherein said perfusion is performed intermittently, whereby a perfusion time is less than half of a cycle time.

3. The method according to claim 2, wherein at least one of the following conditions is fulfilled:
said perfusion time is between 1 minute and 30 minutes;
said perfusion time is between 5 minute and 25 minutes;
said perfusion time is between 7 minute and 20 minutes;
said perfusion time is between 10 minute and 15 minutes;
said cycle time is between 10 minutes and 120 minutes;
said cycle time is between 20 minutes and 110 minutes;
said cycle time is between 45 minutes and 90 minutes;
said cycle time is between 60 minutes and 75 minutes;
said perfusion time divided by said cycle time is smaller than 50%;
said perfusion time divided by said cycle time is between 5% and 45%;
said perfusion time divided by said cycle time is between 10% and 30%;
said perfusion time divided by said cycle time is about 20%;
said potassium concentration is between 15 mM and 30 mM;
said potassium concentration is between 18 mM and 28 mM;
said potassium concentration is between 20 mM and 26 mM;
said potassium concentration is between 22 mM and 24 mM;
said oncotic pressure is larger than 30 mmHg;
said oncotic pressure is larger than 40 mmHg;
said oncotic pressure is larger than 50 mmHg;
said oncotic pressure is larger than 60 mmHg;
said oncotic pressure is smaller than 70 mmHg;
said perfusion pressure is between 15 mmHg and 50 mmHg;
said perfusion pressure is between 17 mmHg and 35 mmHg;
said perfusion pressure is between 20 mmHg and 30 mmHg.

4. The method according to claim 1, further comprising:
controlling a perfusion flow rate by said perfusion pressure so that said perfusion pressure is substantially constant and the perfusion flow rate is between predetermined limits.

5. The method according to claim 1, further comprising:
measuring the oxygenation level of fluid exiting the heart during perfusion and controlling the perfusion time so that the perfusion is ended when a predetermined oxygenation level is obtained in the fluid exiting the heart.

6. The method according to claim 1, further comprising:
monitoring at least one of the following parameters of the fluid:
temperature; pressure before the heart; pressure after the heart; flow rate; oxygenation level before the heart; oxygenation level after the heart; pH; carbon dioxide level; color; and
adjusting the perfusion in accordance with at least one of said parameters.

7. The method according to claim 1, further comprising;
circulating said fluid through said container but outside said heart, between the perfusion steps at least shortly before the initiation of perfusion.

8. A device for treatment of a heart after harvesting and before transplantation, comprising:
a container intended to comprise the heart;
a first line for connection to an aorta of the heart;
a fluid circuit comprising an oxygenator for oxygenating said fluid and a possibly a heater/cooler for regulating the temperature of said fluid;
a pump for perfusion of said fluid through the coronary blood vessels of the heart;
wherein
said fluid comprises an oncotic agent exerting an oncotic pressure larger than about 30 mmHg;
said fluid being cardioplegic;
a control device for controlling the pump whereby said perfusion being performed at a pressure which is at least 15 mmHg and is at least 15 mmHg lower than said oncotic pressure.

9. The device according to claim 8, wherein said control device is arranged to perform said perfusion intermittently, whereby a perfusion time is less than half of a cycle time.

10. The device according to claim 8, wherein the cardioplegic solution comprises potassium at a concentration, which is lower than 30 mM, but sufficiently high to cause cardioplegia, such as above about 15 mM.

11. The device according to claim 8, further comprising:
a first clamp arranged on said fluid line outside said container;
a second clamp arranged at a branching line, which branches from said fluid line inside said container shortly before the connection of said fluid line to said aorta, and passes through said second clamp outside said container and back to said container; and
wherein said first clamp is open during perfusion;
said second claim is open shortly before perfusion at the same time as said first clamp is open in order to flush said fluid line before initiation of perfusion.

12. The device according to claim 11, further comprising:
a third clamp arranged at a division line dividing from said first line before said first clamp and ending inside said container; whereby said third claim is open during circulation outside said heart in the container, whereby at the same time at least the first clamp is closed.

13. A fluid for treatment of a heart after harvesting and before transplantation according to the method of claim 1, comprising:
an oncotic agent exerting an oncotic pressure larger than about 30 mmHg;
a cardioplegic substance;
erythrocytes comprising at least a hematocrit of 5%;
a nutritional substance; and
electrolytes in substantially physiologic concentrations.

14. The fluid according to claim 13, wherein said cardioplegic solution is potassium having a concentration, which is lower than 30 mM, but sufficiently high to cause cardioplegia, such as above 15 mM.

15. The fluid according to claim 13, comprising: 60 g/L of Dextran 40; 7.0 g/L of NaCl; 1.71 g/L of KCl; 0.22 g/L of CaCl₂*2H₂O; 0.17 g/L of NaH₂PO₄*H₂O; 1.26 g/L of NaHCO₃; 0.24 g/L of MgCl₂*6H₂O; 1.98 g/L of D(+) glucose, erythrocytes at a hematocrit of at least 5% and optionally 50 ml of albumin (20%).
